(19) United States
(12) Patent Application Publication
(10) Pub. No.: US 2019/0222754 A1
(43) Pub. Date: Jul. 18, 2019

(54) IMAGING APPARATUS, IMAGING METHOD, AND STORAGE MEDIUM

(71) Applicant: CANON KABUSHIKI KAISHA, Tokyo (JP)

(72) Inventor: Genjiro Shibagami, Tokyo (JP)

(21) Appl. No.: 16/247,419

(22) Filed: Jan. 14, 2019

(30) Foreign Application Priority Data
Jan. 17, 2018 (JP) 2018-005716

(51) Int. Cl. H04N 5/232

(52) U.S. Cl. CPC H04N 5/23238; H04N 5/23212

(57) ABSTRACT

An imaging apparatus, which includes an image sensor configured to perform image capturing of a plurality of images while being panned, sets a focus position in an optical axis direction used for the image sensor to perform image capturing, performs composition of a panoramic image, in at least some areas of which each subject existing in each of the areas is in focus, with use of the plurality of images, determines a foreground from the subjects, sets the focus position in such a way as to focus on any of the subjects while the image sensor is being panned, generates the panoramic image with use of the plurality of images, crops the foreground from the image in which the foreground is in focus, and performs the composition on the image in which the subject surrounding the foreground and different from the foreground is in focus.

### BACKGROUND

### Field of the Disclosure

Aspects of the present disclosure generally relate to an imaging apparatus which combines a plurality of images to generate a panoramic image.

### Description of the Related Art

There is a known method of generating a panoramic image by capturing a plurality of images while panning an imaging apparatus, such as a digital camera, and piecing the captured images. Japanese Patent Application Laid-Open No. 2010-28764 discusses a technique to determine a condition of, for example, a focus position prior to performing image capturing of a panoramic image.

However, in a case where, during panning image capturing, a subject located at a distance different from the distance of a subject which has first been made in focus comes to appear in the field of view, a panoramic image in which a subject that is out of focus is included may be captured. For example, in a case where a person and a background are distant from each other, if capturing of a panoramic image is performed with the focus fixed to the background, the person, who appears on the way, may become out of focus. On the other hand, if capturing of a panoramic image is performed with the focus fixed to the person, the background may become out of focus.

### SUMMARY

Aspects of the present disclosure are generally directed to providing an imaging apparatus capable of compositing a panoramic image in a scene in which subjects greatly distant from each other in distance in an optical axis direction exist in a panning region.

According to an aspect of the present disclosure, an imaging apparatus includes an image sensor configured to perform image capturing of a plurality of images while being panned, at least one memory configured to store instructions; and at least one processor in communication with the at least one memory and configured to execute the instructions to set a focus position in an optical axis direction used for the image sensor to perform the image capturing, perform composition of a panoramic image, in at least some areas of which each subject existing in each of the areas is in focus, with use of the plurality of images, and determine a foreground from the subjects, wherein the at least one processor further executes the instructions to set the focus position in such a way as to focus on any of the subjects while the image sensor is being panned, generate the panoramic image with use of the plurality of images, crop the foreground from the image in which the foreground is in focus, and perform the composition on the image in which the subject surrounding the foreground and different from the foreground is in focus.

Further features of the present disclosure will become apparent from the following description of exemplary embodiments with reference to the attached drawings.

### BRIEF DESCRIPTION OF THE DRAWINGS

FIG. 1 is a back surface perspective view illustrating a schematic configuration of a digital camera according to one or more aspects of the present disclosure.

FIG. 2 is a block diagram illustrating a hardware configuration of the digital camera according to one or more aspects of the present disclosure.

FIGS. 3A, 3B, 3C, and 3D are diagrams used to explain a relationship between directions in which the digital camera is moving and cropping areas of image data during panoramic image capturing using a conventional method.

FIGS. 4A, 4B, 4C, 4D, 4E and 4F are diagrams used to explain the flow of composition processing for a panoramic image using a conventional method.

FIGS. 5A, 5B, and 5C are diagrams illustrating panoramic image capturing according to one or more aspects of the present disclosure.

FIG. 6 is a flowchart illustrating panoramic composition according to one or more aspects of the present disclosure.

FIG. 7 is a diagram used to explain the behavior of a light signal falling on each pixel which includes a plurality of photoelectric conversion portions according to one or more aspects of the present disclosure.

FIG. 8 is a flowchart illustrating focus lens movement determination according to one or more aspects of the present disclosure.

### DESCRIPTION OF THE EMBODIMENTS

Various exemplary embodiments, features, and aspects of the disclosure will be described in detail below with reference to the drawings.

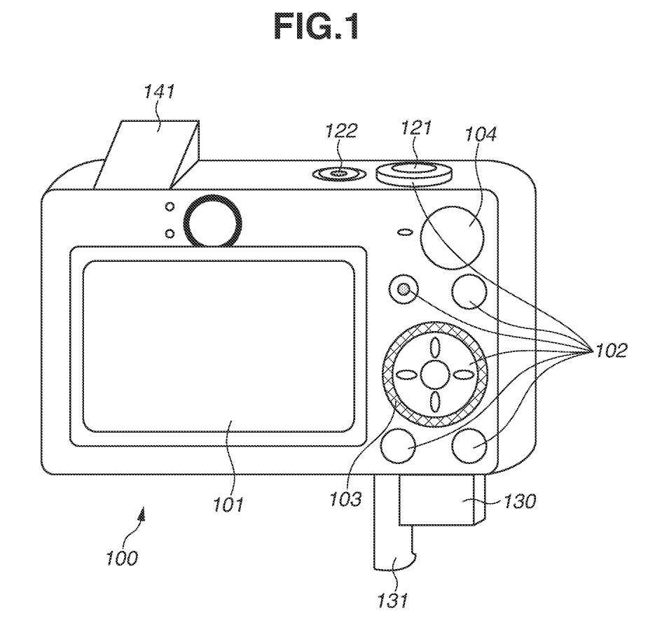

FIG. 1 is a back surface perspective view illustrating a schematic configuration of a digital camera according to an exemplary embodiment of the present disclosure.

The back surface of a digital camera 100 is provided with a display unit 101, which displays an image and various pieces of information, and an operation unit 102, which includes operation components, such as various switches and buttons, used to receive various operations performed by the user. Moreover, the back surface of the digital camera 100 is provided with a mode selection switch 104 for switching between, for example, image capturing modes, and a controller wheel 103 which is able to be operated for rotation. The upper surface of the digital camera 100 is provided with a shutter button 121, which is used to issue an image capturing instruction, a power switch 122, which is used to switch between powering-on and powering-off of the digital camera 100, and a flash unit 141, which illuminates a subject with a flash of light.

The digital camera 100 is able to connect to an external apparatus via wired or wireless communication, and is able to output, for example, image data (still image data or moving image data) to the external apparatus. The lower surface of the digital camera 100 is provided with a recording medium slot (not illustrated), which is openable and closable with a lid 131, and a recording medium 130, such as a memory card, is able to be inserted into or removed from the recording medium slot.

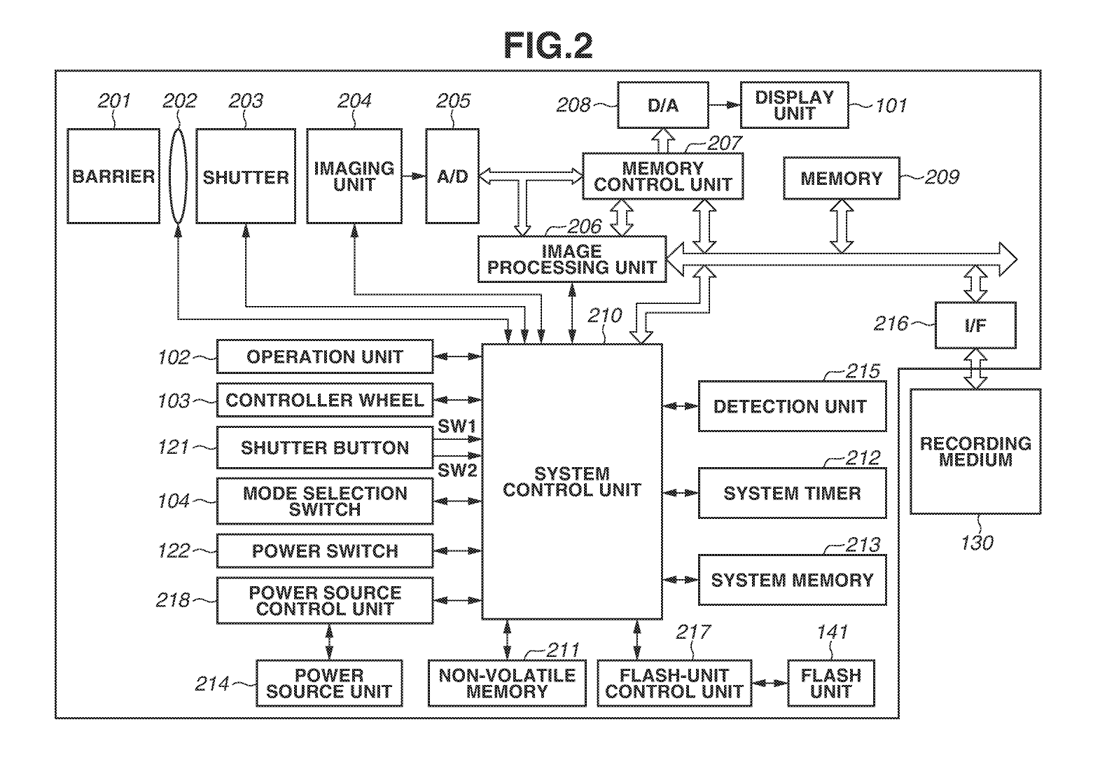

The recording medium 130, which is stored in the recording medium slot, is able to communicate with a system control unit 210 (see FIG. 2) of the digital camera 100. Furthermore, the recording medium 130 is not limited to, for example, a memory card which is able to be inserted into and removed from the recording medium slot, but can be a magnetic disc such as an optical disc or a hard disk or can be incorporated in the body of the digital camera 100.

FIG. 2 is a block diagram illustrating a hardware configuration of the digital camera 100. The digital camera 100 includes a barrier 201, an imaging lens 202, a shutter 203, and an imaging unit 204. The barrier 201 is configured to cover an imaging optical system to protect the imaging optical system from dirt or damage. The imaging lens 202 is composed of a lens group including a zoom lens and a focus lens, and constitutes the imaging optical system. The shutter 203, which has a diaphragm function, adjusts the amount of exposure on the imaging unit 204. The imaging unit 204 is an image sensor which converts an optical image into an electrical signal (analog signal), such as a charge-coupled device (CCD) sensor or a complementary metal-oxide semiconductor (CMOS) sensor, having a Bayer array structure in which red, green, and blue (RGB) pixels are regularly arranged. Furthermore, the shutter 203 can be a mechanical shutter, or can be an electronic shutter, which controls an accumulation time by controlling reset timing of the image sensor.

Alternatively, if the imaging unit 204 is configured to have a structure in which a plurality of photoelectric conversion portions is provided at each pixel to enable acquiring a stereo image, automatic focus detection (AF) processing described below can be performed more quickly.

The digital camera 100 further includes an analog-to-digital (A/D) converter 205, an image processing unit 206, a memory control unit 207, a digital-to-analog (D/A) converter 208, a memory 209, and a system control unit 210. When an analog signal is output from the imaging unit 204 to the A/D converter 205, the A/D converter 205 converts the acquired analog signal into image data composed of a digital signal, and outputs the image data to the image processing unit 206 or the memory control unit 207.

The image processing unit 206 performs, for example, correction processing, such as pixel interpolation or shading correction, white balance processing, gamma correction processing, and color conversion processing on image data acquired from the A/D converter 205 or data acquired from the memory control unit 207. Moreover, the image processing unit 206 implements an electronic zoom function by performing cropping or magnification varying processing of an image. Furthermore, the image processing unit 206 performs predetermined computation processing using image data about the captured image, and the system control unit 210 performs exposure control and distance measurement control based on the thus-obtained result of computation. For example, the system control unit 210 performs autofocus (AF) processing of the through-the-lens (TTL) type, automatic exposure (AE) processing, and electronic flash (EF) processing. The image processing unit 206 performs predetermined computation processing using image data about the captured image, and the system control unit 210 performs automatic white balance (AWB) processing of the TTL type using the thus-obtained result of computation.

The image processing unit 206 includes an image composition processing circuit which composites a panoramic image from a plurality of images and further determines a result of composition of the panoramic image. The image composition processing circuit is able to perform not only simple arithmetic mean composition but also processing such as relatively-bright composition or relatively-dark composition for generating one piece of image data by selecting pixels having the brightest value or darkest value in each area of image data targeted for composition. Moreover, the image processing unit 206 evaluates and determines the result of composition based on a specific criterion. For example, in a case where the number of images used for composition does not reach a predetermined number or a case where the length of an image obtained by composition does not reach a reference value, the image composition processing circuit determines that composition is failed. Furthermore, instead of a configuration including the image processing unit 206, a configuration in which the function of image composition processing is implemented by software processing performed by the system control unit 210 can be employed.

Image data output from the A/D converter 205 is written to the memory 209 via the image processing unit 206 and the memory control unit 207 or via the memory control unit 207. The memory 209 also serves as an image display memory (video memory) which stores image data which is to be displayed on the display unit 101. The memory 209 has a storage capacity capable of storing a predetermined number of still images, a panoramic image (wide-angle image), and a panoramic image composition result. Furthermore, the memory 209 can be used as a work area onto which, for example, a program read out by the system control unit 210 from a non-volatile memory 211 is loaded.

Data for image display (digital data) stored in the memory 209 is transmitted to the D/A converter 208. The D/A converter 208 converts the received digital data into an analog signal and supplies the analog signal to the display unit 101, so that an image is displayed on the display unit 101. The display unit 101, which is a display device such as a liquid crystal display or an organic electroluminescence (EL) display, displays an image based on an analog signal supplied from the D/A converter 208. Turning-on and turning-off of image display in the display unit 101 are switched by the system control unit 210, so that power consumption can be reduced by turning off image display. Furthermore, an electronic viewfinder function for displaying a through-image can be implemented by causing the D/A converter 208 to convert digital signals accumulated from the imaging unit 204 to the memory 209 via the A/D converter 205 into analog signals and sequentially displaying the analog signals on the display unit 101.

The digital camera 100 further includes a non-volatile memory 211, a system timer 212, a system memory 213, a detection unit 215, and a flash-unit control unit 217. The non-volatile memory 211, which is an electrically erasable and storable memory (for example, an electrically erasable programmable read-only memory (EEPROM)), stores, for example, programs which the system control unit 210 executes and constants for operation. Moreover, the non-volatile memory 211 has a region for storing system information and a region for storing user setting information, and the system control unit 210 reads out and restores various pieces of information and settings stored in the non-volatile memory 211 at the time of start-up of the digital camera 100.

The system control unit 210 includes a central processing unit (CPU) and controls the overall operation of the digital camera 100 by executing various program codes stored in the non-volatile memory 211. Furthermore, for example, the programs, constants for operation, and variables read out by the system control unit 210 from the non-volatile memory 211 are loaded onto the system memory 213. A random access memory (RAM) is used as the system memory 213. Moreover, the system control unit 210 performs display control by controlling, for example, the memory 209, the D/A converter 208, and the display unit 101. The system timer 212 measures time used for various control operations and time counted by a built-in clock. The flash-unit control unit 217 controls light emission to be performed by the flash unit 141 according to the brightness of a subject. The detection unit 215, which includes a gyroscope and a sensor, acquires, for example, angular velocity information and orientation information about the digital camera 100. Furthermore, the angular velocity information includes information on an angular velocity and an angular acceleration taken by the digital camera 100 at the time of panoramic image capturing. Moreover, the orientation information includes information on, for example, the inclination of the digital camera 100 with respect to the horizontal direction.

The display unit 101, the operation unit 102, the controller wheel 103, the shutter button 121, the mode selection switch 104, the power switch 122, and the flash unit 141 illustrated in FIG. 2 are the same as those described above with reference to FIG. 1.

Various operation components constituting the operation unit 102 are used, for example, to select various functional icons displayed on the display unit 101, and are assigned the respective functions for scenes by predetermined functional icons being selected. In other words, the operation components of the operation unit 102 operate as various function buttons. Examples of the function buttons include an end button, a back button, an image advance button, a jump button, a stopping-down button, an attribute change button, and a display (DISP) button. For example, when a menu button is pressed, a menu screen used for performing various settings is displayed on the display unit 101. The user is allowed to intuitively perform a setting operation using the menu screen displayed on the display unit 101 and four-direction buttons for up, down, right, and left directions and a setting (SET) button.

The controller wheel 103, which is an operation component able to be rotationally operated, is used, for example, to designate a selection item together with the four-direction buttons. When the controller wheel 103 is rotationally operated, an electrical pulse signal corresponding to the amount of operation (for example, the angle of rotation or the number of rotations) is generated. The system control unit 210 analyzes the generated pulse signal to control each unit of the digital camera 100.

The shutter button 121 corresponds to a first switch SW1 and a second switch SW2. The first switch SW1 is turned on in response to a half-pressed state on the way of operation of the shutter button 121, thus causing a signal for issuing an instruction for preparation of image capturing to be transmitted to the system control unit 210. Upon receiving a signal indicating turning-on of the first switch SW1, the system control unit 210 starts, for example, operations for AF processing, AE processing, AWB processing, and EF processing. The second switch SW2 is turned on in response to a fully-pressed state at completion of operation of the shutter button 121, thus causing a signal for issuing an instruction for starting of image capturing to be transmitted to the system control unit 210. Upon receiving a signal indicating turning-on of the second switch SW2, the system control unit 210 performs a series of image capturing operations leading from signal readout from the imaging unit 204 to write of image data to the recording medium 130.

The mode selection switch 104 is a switch used to switch the operation mode of the digital camera 100 between various modes, such as a still image capturing mode, a moving image capturing mode, and a playback mode. The still image capturing mode includes, in addition to an automatic image capturing mode, a panoramic image capturing mode for compositing a panoramic image by panoramic image capturing.

The digital camera 100 further includes a power source unit 214 and a power source control unit 218. The power source unit 214, which is, for example, a primary battery, such as an alkaline battery or lithium battery, a secondary battery, such as a nickel-cadmium (NiCd) battery, nickel-metal hydride (NiMH) battery, or lithium (Li) battery, or an alternating current (AC) adapter, supplies electric power to the power source control unit 218. The power source control unit 218 detects, for example, the presence or absence of attachment of a battery in the power source unit 214, the type of a battery, and the remaining amount of battery, and supplied required voltages to various portions including the recording medium 130 for required periods based on a result of the detection and an instruction from the system control unit 210.

The digital camera 100 further includes a recording medium interface (I/F) 216, which enables communication between the recording medium 130 and the system control unit 210 when the recording medium 130 is attached to the recording medium slot (not illustrated). Details of the recording medium 130 have already been described above with reference to FIG. 1, and are, therefore, omitted from description here.

Next, a method for panoramic image capturing and a method of compositing a panoramic image from a plurality of images are described. First, processing for cropping a predetermined area from image data about a captured image to composite a panoramic image is described.

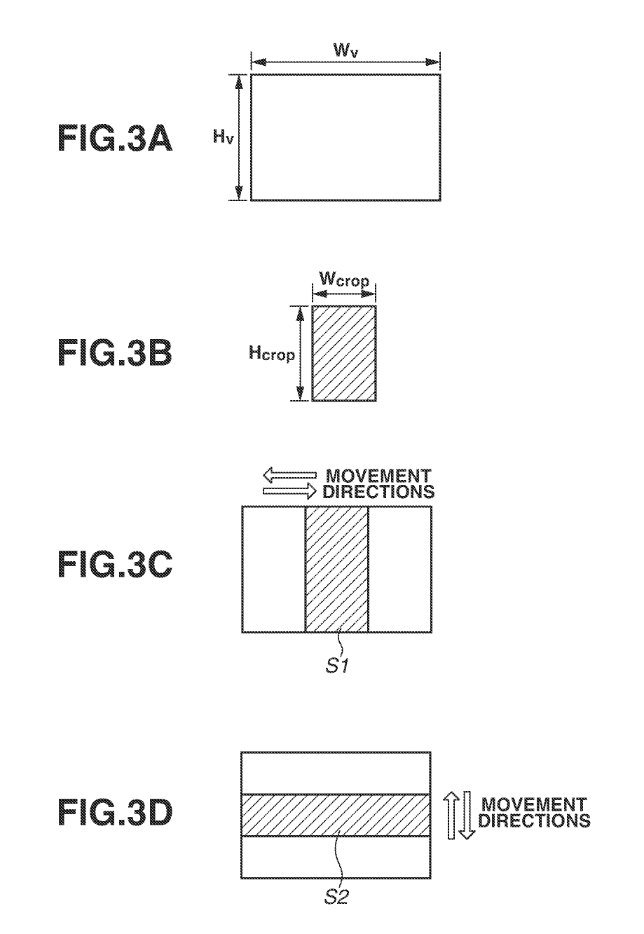

FIGS. 3A, 3B, 3C, and 3D are diagrams used to explain a relationship between directions in which the digital camera 100 is moving and cropping areas of image data during panoramic image capturing using a conventional method.

FIG. 3A illustrates an effective image region of an image sensor included in the imaging unit 204, in which “Wv” indicates the number of effective pixels in the horizontal direction and “Hv” indicates the number of effective pixels in the vertical direction. FIG. 3B illustrates a cropping area, which is cropped from image data about a captured image, in which “Wcrop” indicates the number of cropped pixels in the horizontal direction and “Hcrop” indicates the number of cropped pixels in the vertical direction.

FIG. 3C is a diagram illustrating a cropping area which is obtained with respect to image data when panoramic image capturing is performed while the digital camera 100 is moving in the horizontal directions indicated by arrows. In FIG. 3C, an area S1 indicated by hatching represents a cropping area obtained from image data, and satisfies the following formulae (1) and (2):

Wv>Wcrop (1)

Hv=Hcrop (2)

Similarly, FIG. 3D is a diagram illustrating a cropping area which is obtained with respect to image data when panoramic image capturing is performed while the digital camera 100 is moving in the vertical directions indicated by arrows. In FIG. 3D, an area S2 indicated by hatching represents a cropping area obtained from image data, and satisfies the following formulae (3) and (4):

Wv=Wcrop (3)

Hv>Hcrop (4)

A cropping area of image data about a captured image can be made different depending on pieces of image data. Moreover, with respect to image data obtained at the time of starting of panoramic image capturing and image data obtained at the time of ending of panoramic image capturing, a cropping area can be made wider to increase the angle of view. The method of determining a cropping area of image data includes, for example, determining the cropping area according to, for example, a difference between the angle of the digital camera 100 taken immediately after image capturing and the angle of the digital camera 100 taken one frame before. Cropping and storing only pieces of image data required for composition processing for a panoramic image enables saving the storage capacity of the memory 209.

Next, the method of compositing a panoramic image is described. The system control unit 210 reads out cropping areas stored at the time of panoramic image capturing from the memory 209, and performs panoramic composition on the read-out pieces of image data.

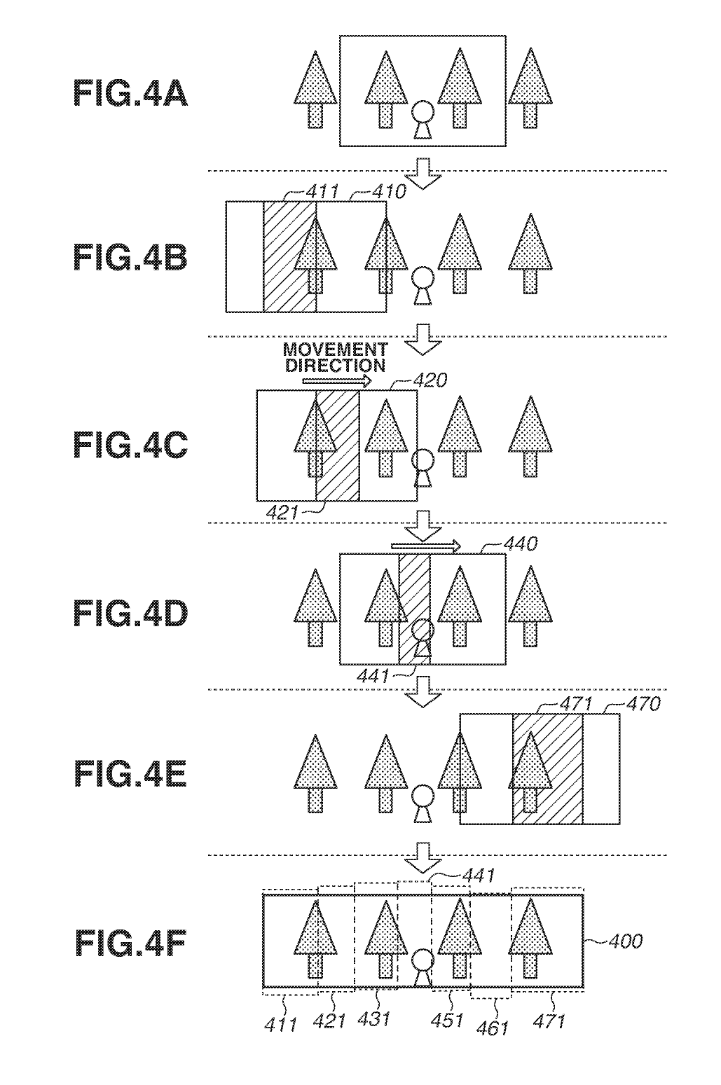

FIGS. 4A, 4B, 4C, 4D, 4E and 4F are diagrams used to explain the flow of composition processing for a panoramic image using a conventional method. In FIGS. 4A to 4F, dot-hatched areas are areas schematically representing a line of trees included in the field of view, and a diagonal-hatched area represents a cropping area in image data. FIG. 4A illustrates a state in which the user has pressed the shutter button 121 so that the first switch SW1 has been turned on and the user is then performing focusing on a main subject. FIG. 4B illustrates a state in which the second switch SW2 of the shutter button 121 has been turned on and the user is then setting the angle of view in agreement with one end of a panoramic image intended to be composited. In the state illustrated in FIG. 4B, the imaging unit 204 captures an image 410. FIGS. 4C to 4E schematically illustrate a state in which the user is performing panoramic image capturing while moving the digital camera 100 toward the other end of the panoramic image intended to be composited. FIG. 4E illustrates a state in which the user has stopped pressing the shutter button 121, so that panoramic image capturing has ended. In the states illustrated in FIGS. 4B to 4E, the imaging unit 204 has captured a total of seven images including images 410 to 470, in which, however, images 430, 450, and 460 are not illustrated. The image processing unit 206 performs cropping processing on the images 410 to 470 captured by the imaging unit 204, thus generating cropping areas 411 to 471. In the system control unit 210, the width of a cropping area can be previously determined, but can be varied according to, for example, the movement speed of the digital camera 100 during panoramic image capturing.

FIG. 4F illustrates a panoramic image obtained by the image processing unit 206 combining a plurality of images captured by the imaging unit 204. Here, the system control unit 210 performs position adjustment on images before performing composition. Moreover, since the upper sides and lower sides of the cropping areas 411 to 471 are not in agreement with each other due to, for example, camera shake, the image processing unit 206 also performs cropping processing with respect to the vertical direction. As a result, the image processing unit 206 generates a panoramic image such as that represented by an area 400.

The system control unit 210 performs position adjustment based on a plurality of motion vectors detected by the image processing unit 206. As an example, the image processing unit 206 divides a cropping area into small blocks with a given size and then calculates a corresponding point at which the sum of absolute differences (SAD) in luminance becomes minimum for each small block. The system control unit 210 is able to calculate a motion vector based on the calculated corresponding points at which the SAD becomes minimum. Besides the SAD, the system control unit 210 can use, for example, the sum of squared differences (SSD) or the normalized cross correlation (NCC).

In FIGS. 4A to 4F, the cropping areas 411 to 471 are illustrated, for ease of reference, in such a way as to have no mutually overlapping areas and to be adjacent to each other. However, actually, to perform processing for position adjustment using, for example, the SAD, overlapping areas are required to exist in cropping areas. If overlapping areas exist, with the middle of each overlapping area used as a boundary, the image processing unit 206 outputs pixel information about one side cropping area on the left side of the boundary and pixel information about the other side cropping area on the right side of the boundary to a composite image. Alternatively, the image processing unit 206 outputs a value obtained by combining 50% of pixel information about one side cropping area and 50% of pixel information about the other side cropping area onto the boundary and performs composition while making the proportion of one side cropping area on the left side of the boundary larger and making the proportion of the other side cropping area on the right side of the boundary larger with the increasing distance from the boundary.

The above-mentioned method of compositing a panoramic image is just premised on focusing on a person situated on the near side. However, in some cases, there is a scene in which it is also intended to focus on a tree located at the back. In the above-mentioned method, since a focus position is determined at the time of the stage illustrated in FIG. 4A and image capturing then continues without change in the focus position, it is impossible to focus on a tree located at the back.

To enable focusing on a tree located at the back, the following method of implementation can be conceived. Specifically, focusing is performed each time image capturing is performed, and image capturing is performed with each measured focus position. In the example illustrated in FIGS. 4A to 4F, focusing is not performed at the time of the stage illustrated in FIG. 4A, but focusing is performed before each of the images 410 to 470 is captured.

However, if focusing is to be performed before each image is captured, two subjects respectively located on the near side and at the back may exist in an area 441 to be cropped, as in an image 440. If the distance in the optical axis direction between two subjects respectively located on the near side and at the back is long, it is impossible to acquire such an area 441 as to focus on both subjects from an image obtained by one image capturing operation, so that one of the subjects may be blurred in a composite image.

To address the above-mentioned issue, the present exemplary embodiment is configured to composite a panoramic image by performing image capturing while moving the position of a focus lens during panning based on distance information about a subject and extracting a subject area which is in focus.

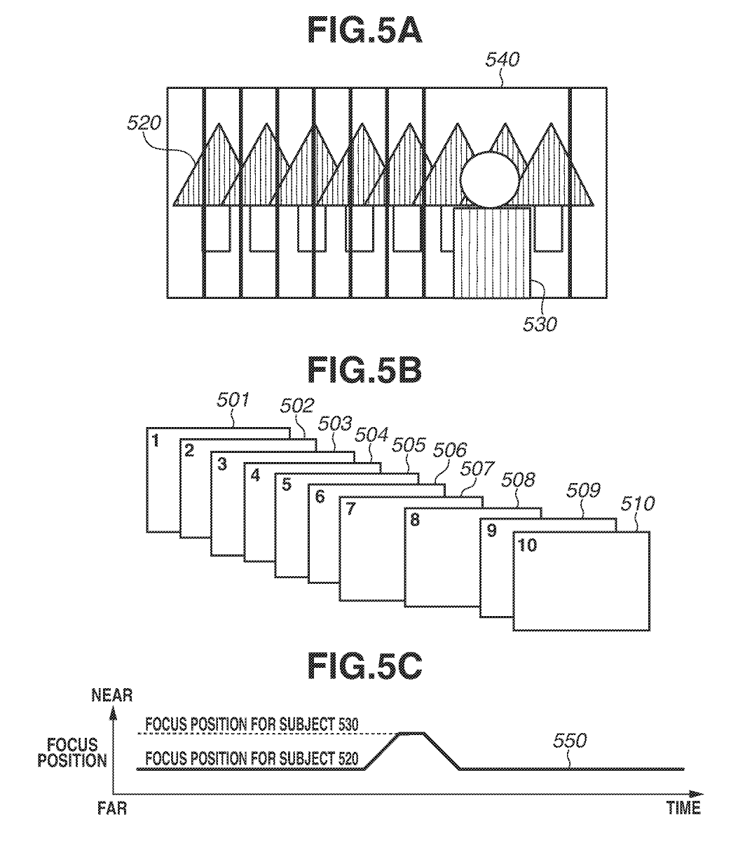

FIGS. 5A, 5B, and 5C are diagrams illustrating panoramic image capturing in the present exemplary embodiment. FIGS. 5A and 5B illustrate a manner in which the system control unit 210 composites a composite image 540 using images 501 to 510. In the composite image 540, a subject 520 located at the back (a background) and a subject 530 located on the near side (a foreground) are shown. FIG. 5C also illustrates a manner in which the focus position is continuously changing in a part of the process in which the imaging unit 204 is capturing images (while the imaging unit 204 is capturing images 506 to 508).

Line 550 indicates a change in the focus position during panning, thus indicating that the focus position becomes adjusted to the subject 530 in the vicinity of a position where the image 508 is captured and also indicating that the focus position becomes adjusted to the subject 520. Among the images 501 to 510 used to generate the composite image 540, an image capturing interval between the image 508 and an image adjacent thereto is longer than image capturing intervals between the other images. Thus, the image capturing interval becomes longer according to a change in focus position.

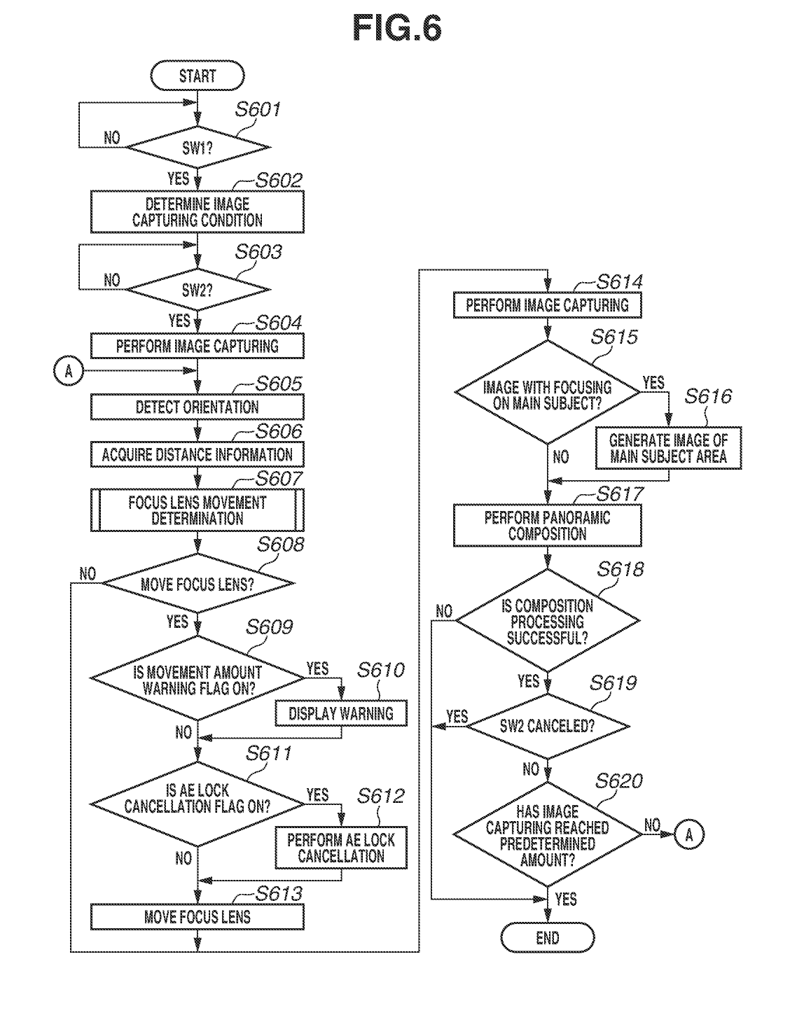

FIG. 6 is a flowchart illustrating panoramic composition in the present exemplary embodiment. Furthermore, the term “distance” as used in the following description refers to a distance in the optical axis direction unless otherwise stated.

In step S601, the system control unit 210 determines whether the first switch SW1 has been turned on, and, if it is determined that the first switch SW1 has been turned on (YES in step S601), the processing proceeds to step S602.

In step S602, the system control unit 210 performs AE processing and AF processing to determine an image capturing condition (for example, an exposure, an image capturing sensitivity, and WB). Moreover, in step S602, the system control unit 210 can determine, for example, the number of images to be used to composite a panoramic image or the size of a panoramic image.

In step S603, the system control unit 210 determines whether the second switch SW2 has been turned on, and, if it is determined that the second switch SW2 has been turned on (YES in step S603), the processing proceeds to step S604.

In step S604, the imaging unit 204 captures one image under the image capturing condition determined in step S602.

In step S605, the detection unit 215 detects the orientation of the digital camera 100, which is performing image capturing. Then, in step S605, the system control unit 210 is able to calculate an angle by which panning has been performed during image capturing of two images, with use of information about the orientation detected by the detection unit 215.

In step S606, the imaging unit 204 acquires distance information. Each pixel included in the imaging unit 204 is configured to include a plurality of photoelectric conversion portions, so that the imaging unit 204 is able to acquire distance information in the following way.

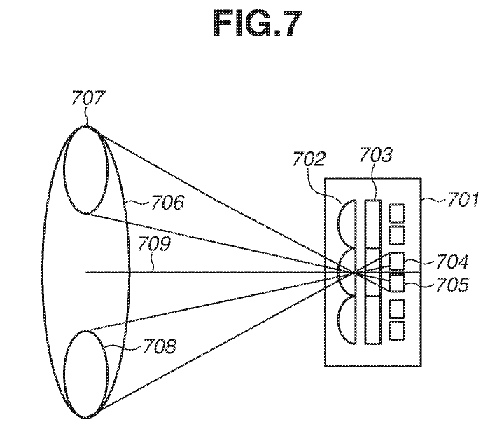

FIG. 7 is a diagram used to explain the behavior of a light signal falling on each pixel which includes a plurality of photoelectric conversion portions in the present exemplary embodiment.

Referring to FIG. 7, a pixel array 701 includes microlenses 702, color filters 703, and pairs of photoelectric conversion portions 704 and 705. The photoelectric conversion portions 704 and 705 belong to the same pixel and correspond to one microlens 702 and one color filter 703 in common. FIG. 7 is a diagram obtained when the digital camera 100 is viewed from above, thus illustrating two photoelectric conversion portions 704 and 705 corresponding to one pixel being arranged side by side in the horizontal direction. Out of light fluxes exiting from an exit pupil 706, a light flux on the upper side of the optical axis 709 (equivalent to a light flux coming from an area 707) falls on the photoelectric conversion portion 705 and a light flux on the lower side of the optical axis 709 (equivalent to a light flux coming from an area 708) falls on the photoelectric conversion portion 704. In other words, the photoelectric conversion portions 704 and 705 receive light fluxes coming from respective different areas of the exit pupil of the imaging lens 202. Here, assuming that a signal obtained by the photoelectric conversion portion 704 receiving light is an image A and a signal obtained by the photoelectric conversion portion 705 receiving light is an image B, a focus deviation amount is able to be calculated based on a phase difference between a pair of pupil-divided images such as the image A and the image B, so that distance information can be acquired.

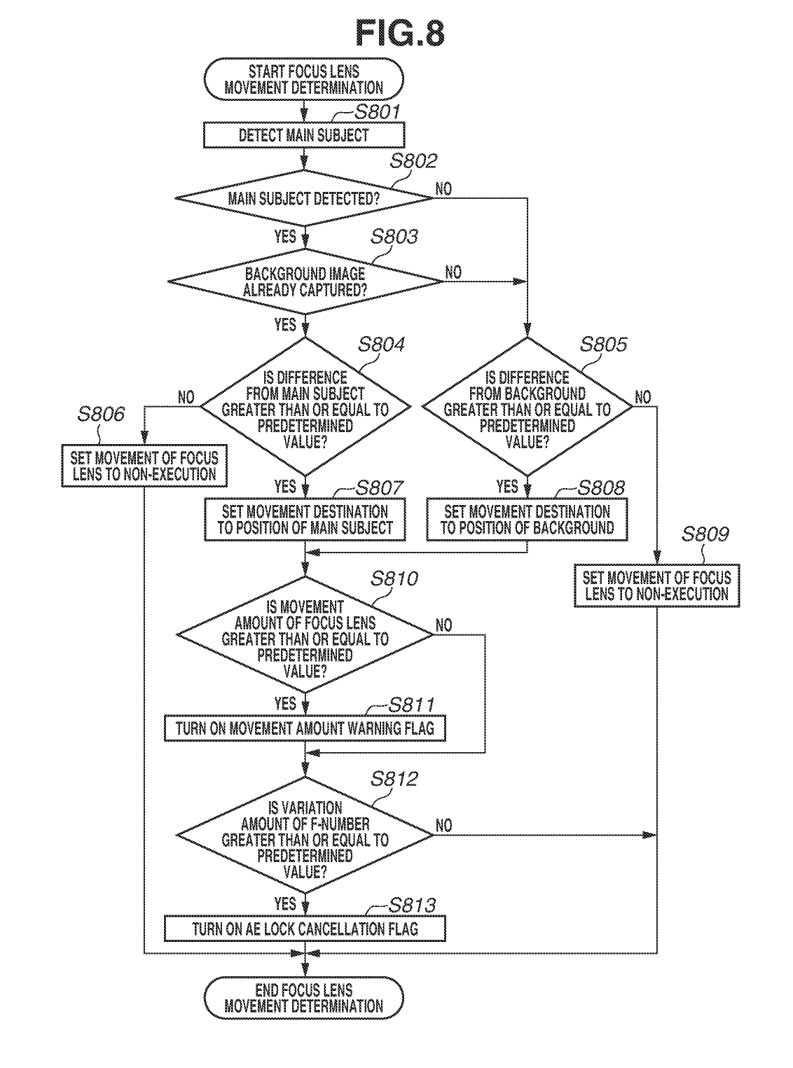

Referring back to FIG. 6, in step S607, the system control unit 210 performs movement determination of the focus lens. Details thereof are described with reference to FIG. 8.

FIG. 8 is a flowchart illustrating focus lens movement determination in the present exemplary embodiment.

In step S801, the system control unit 210 performs detection of a main subject. The detection of a main subject can be performed, for example, with use of a known face detection method of, for example, detecting the face of a person based on partial features thereof, such as eyes and mouth, included in a target image. Moreover, a subject to be regarded as a main subject can be a face that is determined to be the same person as face information previously registered with the digital camera 100. Alternatively, upon detecting that the face and the body are shown in a captured image, the system control unit 210 can determine that a main subject has been detected. Whether the body is shown in a captured image can be determined by detecting, based on distance information about the image, that there is a particular area having distance information that is within a predetermined range from the face area below the face and there are areas having distance information that is farther than the face area at the right and left sides of the particular area. Moreover, even if no face has been detected, in a case where it is determined that a subject which has appeared while the digital camera 100 is being moved is a person, the system control unit 210 can determine that a main subject has been detected.

If, in step S802, the system control unit 210 determines that a main subject has been detected (YES in step S802), the processing proceeds to step S803, and, if not (NO in step S802), the processing proceeds to step S805.

In step S803, the system control unit 210 determines whether, out of images captured up to now, an image serving as an area for the background of a main subject has already been captured. Specifically, as illustrated in FIG. 5A, the system control unit 210 regards an area located around the main subject and near the main subject as a background for the main subject and determines whether an image involving the background for the main subject has been captured. The area located near the main subject includes an area which is caused by a swing operation to appear in the angle of view after the main subject. The image involving the background for the main subject becomes required when an image of the area for the main subject is later combined with an image of the background area. If such an image does not exist, to capture an image involving an area of the background for the main subject, the processing proceeds to step S805.

If, in step S803, the system control unit 210 determines that an image involving the background for the main subject has already been captured (YES in step S803), the processing proceeds to step S804, and, if not (NO in step S803), the processing proceeds to step S805.

In step S804, the system control unit 210 determines whether a difference between the current focus position of the optical system and the distance information about the main subject acquired in step S606 is greater than or equal to a predetermined value. The predetermined value as used here is a lower limit of the difference according to which blurring is deemed to occur at the main subject when image capturing is performed with the current focus position of the optical system. If it is determined that the difference is greater than or equal to the predetermined value (YES in step S804), the processing proceeds to step S807, in which the system control unit 210 sets the movement destination of the focus position to the position of the main subject. If it is determined that the difference is less than the predetermined value (NO in step S804), the processing proceeds to step S806, in which the system control unit 210 sets the movement of the focus lens to non-execution.

Similarly, in step S805, the system control unit 210 determines whether a difference between the current focus position of the optical system and distance information about an area dominant in the background included in the distance information acquired in step S606 is greater than or equal to a predetermined value. The area dominant in the background can be an area which becomes largest in size when background areas are grouped based on distance information or an area located at the center of the image capturing angle of view. If it is determined that the difference is greater than or equal to the predetermined value (YES in step S805), the processing proceeds to step S808, in which the system control unit 210 sets the movement destination of the focus position to the position of the area dominant in the background. If it is determined that the difference is less than the predetermined value (NO in step S805), the processing proceeds to step S809, in which the system control unit 210 sets the movement of the focus lens to non-execution. The predetermined value used in step S804 and the predetermined value used in step S805 can be the same value, or can be set according to the depth of field corresponding to the current focus position of the optical system.

After setting the movement of the focus lens to non-execution in any of step S806 and step S809, the system control unit 210 ends the flow of the processing.

On the other hand, after the setting in step S807 or step S808 is performed, the processing proceeds to step S810, in which the system control unit 210 determines whether the movement amount of the focus lens is greater than or equal to a predetermined value. If the movement amount is greater than or equal to the predetermined value (YES in step S810), since the movement of the focus lens requires long time and, therefore, it may become impossible to appropriately combine images, then in step S811, the system control unit 210 turns on a movement amount warning flag. Then, in step S812, the system control unit 210 determines whether the variation amount of the F-number is greater than or equal to a predetermined value. When the focus lens is moved, the F-number varies. In a case where the variation amount of the F-number is large, if AE is kept locked, the digital camera 100 is not able to capture an image with an appropriate exposure. Accordingly, in step S813, the system control unit 210 turns on an AE lock cancellation flag.

Referring back to FIG. 6, in step S608, the system control unit 210 determines whether to move the focus lens, based on a result of the determination performed in step S607. If it is determined to move the focus lens (YES in step S608), the processing proceeds to step S609, and, if it is determined not to move the focus lens (NO in step S608), the processing proceeds to step S614.

If, in step S609, it is determined that the movement amount warning flag is in an on-state (YES in step S609), the processing proceeds to step S610, in which the display unit 101 displays a warning which prompts the user to perform panning slowly. If, in step S611, it is determined that the AE lock cancellation flag is in an on-state (YES in step S611), the processing proceeds to step S612, in which the system control unit 210 performs AE lock cancellation. After performing AE lock cancellation, the system control unit 210 re-performs AE processing here.

In step S613, the system control unit 210 moves the focus lens.

In step S614, the imaging unit 204 performs image capturing.

In step S615, the system control unit 210 determines whether an image captured by the imaging unit 204 in step S614 is an image obtained with focusing on a main subject. If it is determined that the captured image is an image obtained with focusing on a main subject (YES in step S615), since, with respect to an area in which the main subject exits, it is necessary to generate an image obtained by cropping a main subject area, the processing proceeds to step S616. If it is determined that the image captured by the imaging unit 204 in step S614 is not an image obtained with focusing on a main subject (NO in step S615), the processing proceeds to step S617.

In step S616, the system control unit 210 generates an image of the main subject area. For example, the image of the main subject area is generated in step S616 by recognizing a main subject in an image recognition method similar to that in step S801 and cropping a portion corresponding to the area of the main subject. Alternatively, a portion corresponding to the area of the main subject can be cropped with use of edge detection. In this method, position adjustment between two images, i.e., an image involving a background for the main subject and an image obtained with focusing on the main subject, is performed. Even for position adjustment between two images, which are images captured with respective different focus positions, therefore, the image processing unit 206 decreases the degrees of resolution of two images to equalize the degrees of blurring thereof and then calculates the position deviation amount between two images. Then, the system control unit 210 extracts edges from each of two images obtained after position adjustment performed based on the calculated position deviation amount. The system control unit 210 is able to determine that, out of edges extracted from the image obtained with focusing on a main subject, edges the edge level of which is higher by a threshold value or more than edges in an image involving the background for the main subject serve a contour of the main subject area.

In step S617, the image processing unit 206 performs position adjustment of a new captured image with respect to a panoramic image which is in the process of being generated and then combines these images. Specifically, in a case where a new captured image is not an image obtained with focusing on a main subject, the image processing unit 206 crops an area in a rectangular shape such as that illustrated in FIG. 3B, performs position adjustment between the cropped area and a panoramic image which is in the process of being generated, and performs composition. With this, the size of the panoramic image is enlarged.

In a case where a new captured image is an image obtained with focusing on a main subject, the image processing unit 206 performs position adjustment between an image of the main subject area cropped in step S616 and a panoramic image with which an image involving the background for the main subject has been combined, and performs composition. In this case, the size of the panoramic image is not changed, but, in a panoramic image generated with images captured with focusing on the background, an image of the area of the main subject is replaced by an image captured with focusing on the main subject.

In step S618, the system control unit 210 determines whether composition processing is successful. A case where composition processing is not successful is, for example, a case where an overlapping portion of cropping areas between adjacent images, i.e., an overlapping portion of areas used for composition of a panoramic image, has become small. If it is determined that composition processing is not successful (NO in step S618), the system control unit 210 ends the flow of the processing. If it is determined that composition processing is successful (YES in step S618), the processing proceeds to step S619, in which the system control unit 210 determines whether the second switch SW2 has been canceled. If it is determined that the second switch SW2 has been canceled (YES in step S619), the system control unit 210 ends the flow of the processing, and, if it is determined that the second switch SW2 has not been canceled (NO in step S619), the processing proceeds to step S620. In step S620, the system control unit 210 determines whether image capturing has reached a predetermined amount. The predetermined amount refers to, for example, the number of images or the upper limit of the size determined in step S602. If it is determined that image capturing has reached the predetermined amount (YES in step S620), the system control unit 210 ends the flow of the processing, and, if it is determined that image capturing has not reached the predetermined amount (NO in step S620), the processing returns to step S605.

As described above, the system control unit 210 determines whether to move the focus lens and, when determining to move the focus lens, determines the movement destination of the focus position.

According to the present exemplary embodiment, in panoramic image capturing, when subjects distant from each other in the optical axis direction exist, the digital camera determines whether it is necessary to move the focus lens, thus being able to composite a panoramic image with focusing on both subjects located on the near side and at the back.

Furthermore, while, in the above-described exemplary embodiment, description has been made based on a personal digital camera, the present exemplary embodiment can also be applied to, for example, a mobile device, a smartphone, or a network camera connected to a server, as long as it is equipped with panoramic image capturing and composition functions.

Furthermore, the present disclosure can also be implemented by processing for supplying a program for implementing one or more functions of the above-described exemplary embodiment to a system or apparatus via a network or a recording medium and causing one or more processors in a computer of the system or apparatus to read out and execute the program. Moreover, the present disclosure can also be implemented by a circuit which implements one or more functions (for example, an application specific integrated circuit (ASIC)).

According to a configuration of the present disclosure, an imaging apparatus capable of compositing a panoramic image with a small feeling of strangeness even if there are subjects greatly distant from each other in the optical axis direction in a panning area can be provided.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2018-005716, filed Jan. 17, 2018, which is hereby incorporated by reference herein in its entirety.

What is claimed is:

1. An imaging apparatus comprising:
an image sensor configured to perform image capturing of a plurality of images while being panned;
at least one memory configured to store instructions; and
at least one processor in communication with the at least one memory and configured to execute the instructions to:
set a focus position in an optical axis direction used for the image sensor to perform the image capturing;
perform composition of a panoramic image, in at least some areas of which each subject existing in each of the areas is in focus, with use of the plurality of images; and
determine a foreground from the subjects,
wherein the at least one processor further executes the instructions to:
set the focus position in such a way as to focus on any of the subjects while the image sensor is being panned;
generate the panoramic image with use of the plurality of images;
crop the foreground from the image in which the foreground is in focus; and
perform the composition on the image in which the subject surrounding the foreground and different from the foreground is in focus.

2. The imaging apparatus according to claim 1, wherein the at least one processor further executes the instructions to continuously change the focus position in at least a part of a process of the panning while the image sensor is being panned.

3. The imaging apparatus according to claim 1, wherein an image capturing interval taken by the image sensor performing the image capturing when the at least one processor further executes the instructions to change the focus position is longer than an image capturing interval taken by the image sensor performing the image capturing when the at least one processor further executes the instructions not to change the focus position.

4. The imaging apparatus according to claim 1, wherein the panoramic image is an image in which, in at least areas including the foreground, the subject in each of the areas is in focus.

5. The imaging apparatus according to claim 1, wherein the at least one processor further executes the instructions to determine the foreground with use of image recognition.

6. The imaging apparatus according to claim 1, wherein the foreground is a person.

7. The imaging apparatus according to claim 1, wherein the at least one processor further executes the instructions to determine a background different in distance in the optical axis direction from the foreground.

8. The imaging apparatus according to claim 7, wherein, in a case where the image sensor captures an image including the foreground and the background, the at least one processor further executes the instructions to:
set the focus position to the foreground in a case where image capturing of the background has already been performed; and
set the focus position to the background in a case where image capturing of the background has not been performed.

9. The imaging apparatus according to claim 1, wherein the at least one processor further executes the instructions to issue a warning when an amount by which to change the focus position exceeds a predetermined amount.

10. The imaging apparatus according to claim 1, wherein the at least one processor further executes the instructions to acquire distance information about a plurality of subjects.

11. The imaging apparatus according to claim 10, wherein the at least one processor further executes the instructions to determine the foreground with use of the distance information.

12. The imaging apparatus according to claim 10, wherein the at least one processor further executes the instructions to set the focus position in such a manner that any of the subjects is in focus, based on the acquired distance information.

13. The imaging apparatus according to claim 10, wherein the at least one processor further executes the instructions to acquire the distance information with use of a stereo image.

14. The imaging apparatus according to claim 13,
wherein the image sensor has a structure including a plurality of photoelectric conversion portions for each pixel, and
wherein the at least one processor further executes the instructions to acquire the stereo image by use of the structure including a plurality of photoelectric conversion portions for each pixel.

15. A method for controlling an imaging apparatus, the imaging apparatus including an image sensor configured to perform image capturing of a plurality of images while being panned, at least one memory configured to store instructions, and at least one processor in communication with the at least one memory and configured to execute the instructions, the method comprising:
setting a focus position in an optical axis direction used for the image sensor to perform the image capturing;
performing composition of a panoramic image, in at least some areas of which each subject existing in each of the areas is in focus, with use of the plurality of images;
determining a foreground from the subjects;
setting the focus position in such a way as to focus on any of the subjects while the image sensor is being panned;
generating the panoramic image with use of the plurality of images;
cropping the foreground from the image in which the foreground is in focus; and
performing the composition on the image in which the subject surrounding the foreground and different from the foreground is in focus.

16. A computer-readable storage medium storing instructions that cause a computer to execute a method for controlling an imaging apparatus, the imaging apparatus including an image sensor configured to perform image capturing of a plurality of images while being panned, at least one memory configured to store instructions, and at least one processor in communication with the at least one memory and configured to execute the instructions, the method comprising:
setting a focus position in an optical axis direction used for the image sensor to perform the image capturing;
performing composition of a panoramic image, in at least some areas of which each subject existing in each of the areas is in focus, with use of the plurality of images;
determining a foreground from the subjects;
setting the focus position in such a way as to focus on any of the subjects while the image sensor is being panned;
generating the panoramic image with use of the plurality of images;
cropping the foreground from the image in which the foreground is in focus; and
performing the composition on the image in which the subject surrounding the foreground and different from the foreground is in focus.
